(19) United States
(12) Patent Application Publication
(10) Pub. No.: US 2025/0337171 A1
(43) Pub. Date: Oct. 30, 2025

(54) SCALABLE INTELLIGENT REFLECT ARRAY WITH RFID CONTROL FOR WIRELESS COMMUNICATION

(71) Applicant: NXP USA, Inc., Austin, TX (US)

(72) Inventors: Saeid Alamdar, Irvine, CA (US); Sai-Wang Tam, Sunnyvale, CA (US); Jeremy Robert Baxter, Laguna Niguel, CA (US); Peter Thüringer, Graz (AT); Rui Cao, Sunnyvale, CA (US); Franz Amtmann, Graz (AT)

(21) Appl. No.: 18/651,327

(22) Filed: Apr. 30, 2024

(51) Int. Cl. H01Q 15/00; H01Q 3/36; H01Q 9/04; H01Q 21/06; H01Q 23/00

(52) U.S. Cl. CPC H01Q 15/0006; H01Q 3/36; H01Q 9/0414; H01Q 21/065; H01Q 23/00

(57) ABSTRACT

Embodiments of a method and apparatus for an intelligent reflect array are disclosed. In an example, an antenna array includes an array of patch antennas, a plurality of delay elements associated with each patch antenna, and a switch for each patch antenna having multiple positions. Each position is configured to connect one delay element of a respective plurality of delay elements to a respective patch antenna. A controller controls the position of each switch.

### BACKGROUND

A wireless or radio data communication system has a transmitter that transmits data signals through a radio channel to a receiver. The communications are often bi-directional through the radio channel and the propagation of the signals is usually treated as reciprocal in that the same principles and effects apply in both directions. The radio channel is a difficult uncontrollable phenomenon that distorts and obscures and that changes with time and frequency. The data signals interact with physical objects by reflection, absorption, and other effects and the data signals interact with other data signals and radio interferers. This causes a very complex and inconsistent series of constructive and destructive interferences that seem random.

The challenges of the radio channel are most easily addressed with high power, wide band, data signals at frequencies that have good penetration and range. When this approach is not available, as with most data communication systems, sophisticated transmission and reception schemes are employed. Base station (BS), access point (AP) and other transmitter locations are determined based on radio propagation measurements or simulations. Beamforming, pre-distortion, and other methods are employed to maintain the data through the radio channel. When these and other methodologies fail, then the call, session, stream, or transmission is dropped.

An Intelligent Reflect Array (IRA) sometimes referred to as a Reconfigurable Intelligent Surface (RIS) may be used to shape, direct, or form all or part of a radio channel so that radio frequency signals will pass to the receiver when the radio channel otherwise would fail or be limited to lower data rates. The

IRA has an array of independently controllable surfaces that may be used to apply effects to the radio frequency signals (e.g., reflection, refraction, absorption, focusing and polarization). The IRA provides a way to also reduce the effect of interferers that would otherwise be in the radio channel by manipulating radio frequency energy in the radio channel. Compared to a repeater, no additional delay is added, very little power is used, and the radio frequency signals are not vulnerable to interception and demodulation. The IRA can be described as programming the wireless environment with a simplified model of the radio frequency (RF) multipath environment as an assembly of reflecting and diffracting objects. The model may be rendered as a Smart Radio Environment (SRE) or a Software Defined Environment (SDE), enabling greater control and programmability within the wireless communication system.

### SUMMARY

Embodiments of a method and apparatus for an antenna array are disclosed. In an example, an antenna array includes an array of patch antennas, a plurality of delay elements associated with each patch antenna, and a switch for each patch antenna having multiple positions. Each position is configured to connect one delay element of a respective plurality of delay elements to a respective patch antenna. A controller controls the position of each switch.

In some embodiments, the controller comprises a control signal receiver to receive an RF control signal from a remote controller.

In some embodiments, the controller comprises a radio frequency identification chip having a control input to receive a radio control signal and a control output to control the position of each switch.

In some embodiments, the control output is in a form of an Inter-Integrated Circuit protocol.

In some embodiments, the control output includes an address for each switch.

In some embodiments, each respective plurality of delay elements has four delay elements to provide four orthogonal delays.

In some embodiments, each respective switch is a four-throw switch to select one of the four delay elements.

Some embodiments include a transmission line coupled to each respective patch antenna, the transmission line having a stub coupled to the patch antenna, a quarter-wave transformer coupled to the stub, and the respective switch coupled to the quarter-wave transformer.

In some embodiments, the delay elements comprise terminated conductive lines coupled to the switch.

In some embodiments, each patch antenna comprises a main patch with a central aperture on a first layer, a stack patch aligned with the main patch on a second layer, and an excitation aperture aligned with the central aperture on a ground layer, wherein the first layer, the second layer, and the ground layer are attached together.

In some embodiments, the main patch and the stack patch are formed of an approximately square layer of material at the respective layer.

Some embodiments include parasitic elements surrounding each main patch on the first layer.

In an example a method includes receiving a control signal at a control signal receiver of an antenna array, the antenna array having a plurality of delay elements, converting the control signal to a control output at the control signal receiver, and sending the control signal output to a plurality of switches of the antenna array, each switch being coupled to a respective delay element of a patch antenna of the antenna array, to set a delay for the respective patch element.

In some embodiments, the control signal receiver comprises a radio frequency identification chip having a control input to receive a radio control signal and a control output to control the position of each switch.

In some embodiments, sending the control signal output comprises sending an Inter-Integrated Circuit signal.

In some embodiments, sending the control signal output comprises sending an indication of one of four switch positions to each switch.

In some embodiments, sending the control signal output comprises sending a separate two-line control signal to each switch.

In an embodiment a controller includes a control signal receiver configured to receive a control signal through a radio signal and a micro-controller unit (MCU) coupled to the control signal receiver configured to receive the control signal from the control signal receiver and to generate a control output to control the position of each of a plurality of switches, each switch being coupled to a respective delay element of a patch antenna of an antenna array to set a delay for the respective patch element.

In some embodiments, the control signal receiver is positioned on a patch antenna, the controller further comprising a control board configured to carry the MCU and having a connector to connect to the control signal receiver.

In some embodiments, the control signal receiver comprises a radio frequency identification (RFID) chip having a control input. Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 is a diagram of an antenna array in a radio channel between two transceivers in accordance with embodiments.

FIG. 2 is an exploded view diagram of an antenna array in accordance with embodiments.

FIG. 3 is a top plan view of the first layer of the antenna array of FIG. 2 in accordance with embodiments.

FIG. 4 is a top plan view of the second layer of the antenna array of FIG. 2 in accordance with embodiments.

FIG. 5 is a top plan view of the third layer of the antenna array of FIG. 2 in accordance with embodiments.

FIG. 6 is a top plan view of the fourth layer of the antenna array of FIG. 2 in accordance with embodiments.

FIG. 7 is a top plan view of a feed network of the fourth layer of the antenna array of FIG. 2 in accordance with embodiments.

FIG. 8 is a top view diagram of a block of an array showing all four layers superimposed in accordance with embodiments.

FIG. 9 is a top plan view diagram of a control signal receiver in accordance with embodiments.

FIG. 10 shows an example configuration of the control signal receiver in the fourth layer below the control signal antenna of the first layer of the antenna array of FIG. 2 in accordance with embodiments.

FIG. 11 is a process flow diagram of operating an antenna array as described in accordance with embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

The described antenna array, e.g., an intelligent reflect array (IRA) is a programmable surface structure that may be used to control the reflection of RF electromagnetic (EM) waves by changing the electric and magnetic properties of the surface. The structure may be placed in a radio channel between a transmitter and receiver or between transceivers. The antenna array is adjusted to control the way the EM waves reflect off the surface of the antenna array as the EM waves propagate between transceivers. The structure is presented in the form of a 2.4 GHz aperture-coupled array of stacked patch antennas that captures incoming EM wave power and converts the captured power into guided waves through transmission lines. The reradiated EM waves are manipulated in phase using a switch, e.g., a single pole four throw (SP4T) switch, and delay lines. The delay lines control the phase of the reradiated EM wave, or reflection, at each patch antenna of the array which allows the EM wave to be directed, e.g. for beam steering. While the array is described in the context of Wi-Fi, it may be applied to other signal types, modulation schemes, and protocols including Bluetooth, ultra-wideband, cellular, and private band data communications, inter alia.

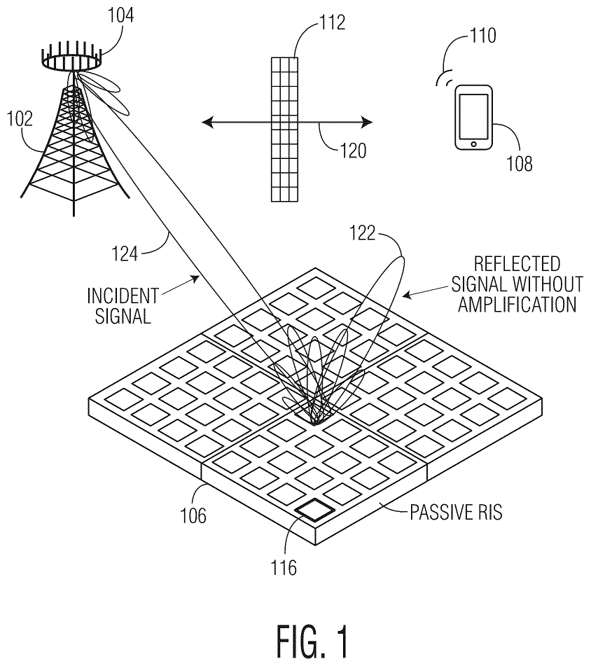

FIG. 1 is a diagram of an antenna array, e.g., an Intelligent Reflect Array (IRA) in a radio channel between two transceivers. The antenna array 106 is between a base station (BS) 102 and a user 108. An obstacle 112 is in the line-of-sight 120 or in another clear path between the BS 102 and the user 108. The obstacle 112 greatly reduces the signal received by the user 108 from the BS 102. The antenna array 106 is used to improve the communication between the BS 102 and the user 108. The BS has an antenna 104 that emits a data signal 124 that propagates toward the antenna array 106, as well as in many other directions.

The antenna array 106 may be configured to form a reflection beam 122 toward an antenna 110 of the user 108. This may be done by setting the phase on the various elements 116 of the antenna array 106 to form or direct the reflection beam 122 in the direction of the user antenna 110. In this example, the antenna array 106 is used to allow the BS 102 and the user 108 to avoid the obstacle 112 by receiving part of the beam 124 from the BS 102 and transmitting a new beam 122 to the user 108, avoiding the obstacle 112. The antenna array 106 may be used in other applications, e.g., range extension, filling in dead spots, avoiding interferers and reflections, etc. A similar approach may be used for transmissions from the user 108 to the BS 102 and for other types of transceivers.

FIG. 1 shows an 8×8 array 106 of patch antennas 116. The structure described below is 4×4 array. The 8×8 structure may be created using four 4×4 arrays and placing them adjacent to one another. Larger arrays may be formed as square arrays, e.g., 16×16, 40×40, etc. or as rectangular arrays of any configuration, e.g., 16×24, 8×40, etc. Mounting brackets, outer frames, adhesives, and other materials may be used to hold the antenna array together with all of the 4×4 panels in place. While the described antenna array may be fabricated with more or fewer patch antennas or block, e.g., 2×2, 10×10, etc., a 4×4 array can be built with high yield using standard materials and machinery. Multiple arrays of the same or different sizes may be combined to achieve a variety of different sized arrays.

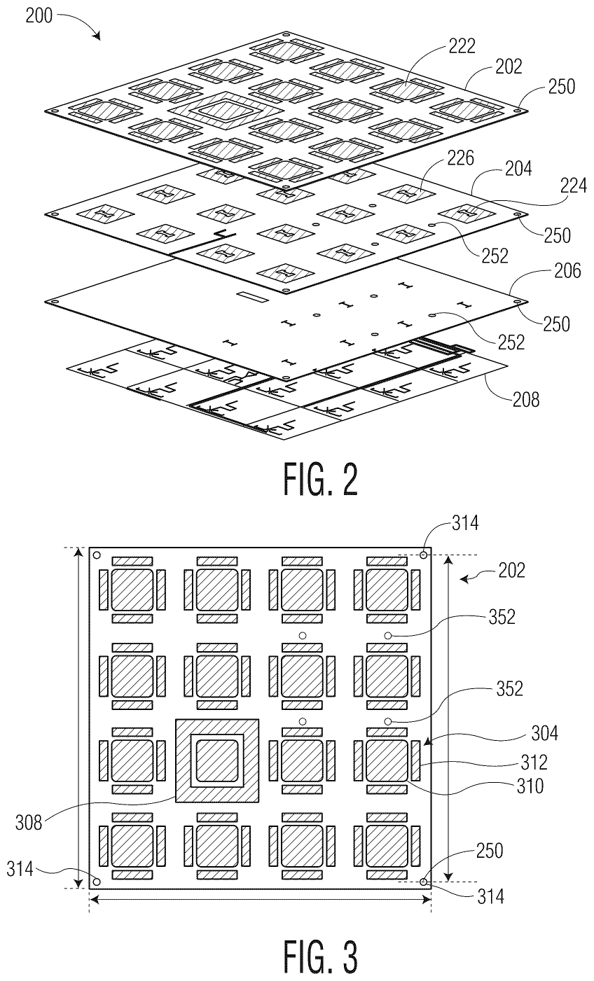

FIG. 2 is an exploded view diagram of an antenna array 200

according to embodiments described herein. The antenna array has four layers described in more detail below. A first layer 202 carries an array of main patch antenna elements 222. A second layer 204 carries an array of stacked patches 226 with central apertures 224, there being an aperture for each patch or antenna element. A third layer 206 is a ground plane with an array of excitation apertures, and a fourth layer 208 is a wiring layer. Each layer is formed on a dielectric sheet, e.g., silicon, pre-impregnated fiberglass, glass, paperboard, etc. to which a conductive pattern is applied by printing, spinning, silk screen, photolithography, etc. The conductive pattern is formed of a suitable metal, e.g. copper or aluminum, or other conductive layer, e.g., carbon. The four layers are stacked together and attached to each other to form an array of stacked patch antenna elements. While the antenna array is shown as having 4×4 patch antennas, there may be more or fewer and multiple arrays of the same or different sizes may be used together to create a larger effective array as shown in FIG. 1.

Each layer optionally has a set of peripheral mounting holes 250, e.g., four mounting holes, that may be used to attach the layers to each other and to attach the layers to brackets, frames or other supporting structure. Each layer optionally also has a set of control board holes 252, e.g., four mounting holes, that may be used to attach a control board to the layers as described in more detail below.

FIG. 3 is a top plan view of the first layer 202 of the antenna array of FIG. 2. The first layer has multiple blocks 304, each of which has the same or a similar design. The design includes a main patch 312, e.g., a 2.4 GHz antenna element in the form a square layer of conductive material. Each main patch is surrounded on each side by a parasitic element 310, in this case four strips or elongated rectangles along the sides of the square. Each of the blocks 304 is the same except that one block has a control antenna 308 in the shape of a rectangle or loop surrounding the main patch. The control antenna 308 is configured to receive a control signal, e.g., a 915 MHz Radio Frequency Identification (RFID) signal. While the control antenna 308 is shown as being in the 3rd row and 2nd column, it may be positioned in any of the 16 blocks.

The array of blocks 304 of the first layer 202 in this example has 16 blocks 304 arranged in 4 rows and 4 columns for a 4×4 array. Multiple arrays may be placed beside each other to create a larger antenna array surface. A larger surface is able to redirect more energy when it receives more of the beam over a larger surface. It may also be able to redirect a beam that is directed in a different direction that might not be incident on a single array. While the array is referred to as containing blocks it may be formed on a single substrate by applying conductive material, e.g., copper, aluminum, in the illustrated pattern. The parasitic and antenna elements may be formed as conductive patterns on a dielectric sheet.

Mounting holes 314 are drilled, cut, punched, machined, or molded at each corner of the first layer. A fastener (not shown), e.g. screw, bolt, rivet, clip, etc. engages the mounting holes to attach the four layers together. Any other fastening technique or structure may be used to attach the four layers together to form the antenna array 200. Control board holes 352 are also optionally formed to attach a control board.

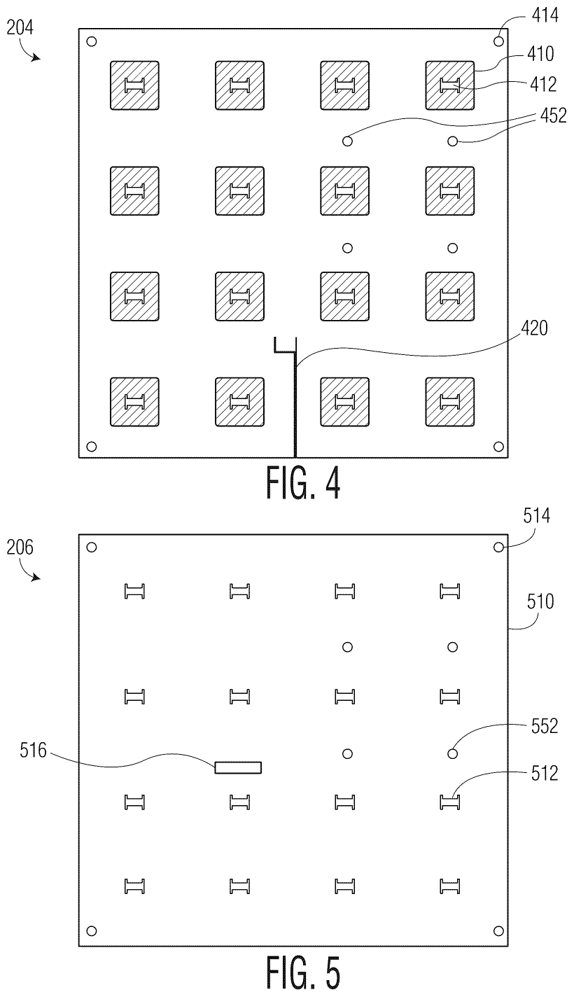

FIG. 4 is a top plan view of the second layer 204 of the antenna array of FIG. 2. The second layer 204 has an array of GHz elements 410. Each GHz element 410 has a square shape for a patch that is aligned with a respective main patch 312 of the first layer for a total of 16 GHz elements in this example. Each GHz element 410 has a central aperture 412 that is elongated in a single direction. The apertures may be formed by die cutting, laser cutting, punching, machining, molding, or any other suitable process depending on the material of the substrate. The second layer 204 also has an optional conductive ground line stub 420 that couples inductively to the control antenna 308 on the first layer 202 and the control signal balun 622 of the fourth layer 208. The elements and lines may be formed as conductive patterns on a dielectric sheet. Mounting holes 414 are formed at each corner of the second layer. Control board holes 452 allow for a control board to be attached at any suitable location.

FIG. 5 is a top plan view of the third layer 206 of the antenna array of FIG. 2. The third layer 206 is a ground plane and therefore it has a conductive surface 510 with holes for various purposes. The third layer may be formed by coating a dielectric with a conductive material or a conductive sheet formed of e.g., copper, aluminum, pre-impregnated carbon fiber, etc. may be used. The third layer has an array of 16 excitation apertures 512 each aligned with a respective one of the central apertures 412 of the second layer. The excitation apertures 512 may each have the same shape as the respective central aperture, namely an elongated rectangular opening. The third layer 206 has mounting holes 514 at each corner with additional holes, e.g., control board holes 552, as appropriate to the intended installation. The third layer also has a control signal excitation aperture 516. The control signal excitation aperture 516 is located below one surface of the control antenna 308.

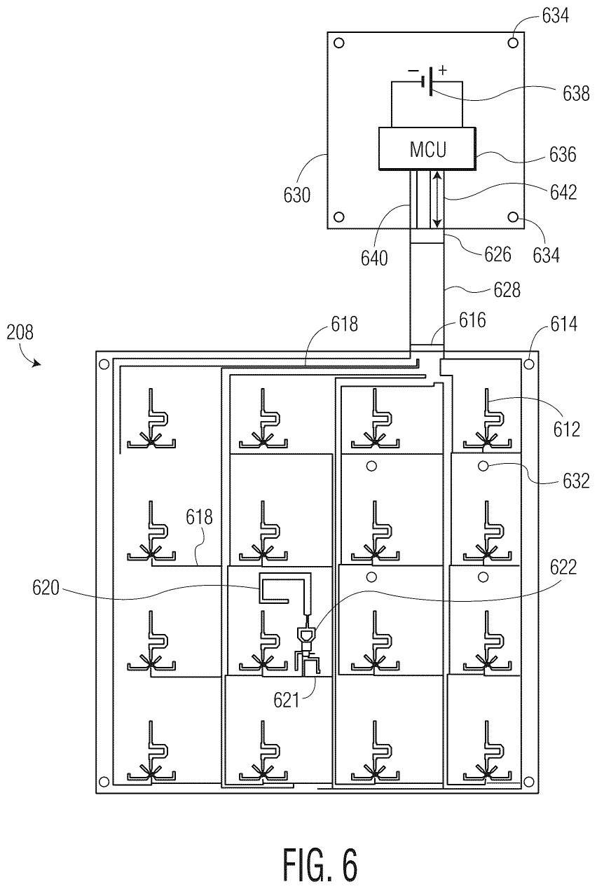

FIG. 6 is a top plan view of the fourth layer 208 of the antenna array of FIG. 2. The fourth layer 208 has an array of 16 feed networks 612, each aligned with a respective main patch 312 of the first layer. An electrical connector 616 connects a cable 628 or other coupler to a control board connector 626 that is attached to a control board 630. The electrical connector 616 allows the control board 630 to receive and transmit signals with each feed network 612 through control lines 618. For a 2-line control signal, there may be 32 control lines 618 to connect each feed network 612 to the electrical connector 616. A control feed network 620 is positioned below the control antenna 308 of the first layer 202.

The control feed network is coupled to a control signal balun 622 as described in more detail below. There may be an additional 2-line control signal 621 to the control signal balun from the electrical connector 616. In addition, the fourth layer may support direct current bias, ground, and other connections at the electrical connector. Mounting holes 614 are formed at each corner of the fourth layer 208.

The control board 630 has peripheral mounting holes 634 configured for use in attaching the control board 630 to the control board holes 632 of the fourth layer. In embodiments the four layers of the antenna array 200 are attached together using the peripheral mounting holes 614. The control board 630 is attached to the fourth layer 208 through the electrical connector 616. A ribbon cable 628 or other flexible connector attaches the electrical connector 612 to the control board. The ribbon cable may include the 16 control lines and the control signal for 34 total wires. After the four layers are attached together, the ribbon cable may be folded so that the control board 630 may be attached to the back side of the fourth layer 208 by aligning the control board holes 632, 634 and using a suitable fastener, e.g., screws, bolts, rivets, adhesive, etc. In this way, the screws further hold the four layers together. Alternatively, the control board may be attached to the fourth layer and then the four layers may be connected together.

The control board 630 has a micro-controller unit (MCU) 636 and a power supply 638, e.g., a battery, attached to the MCU 636 to power the MCU 636. There may be additional components to suit different implementations. The control board 630 may be formed as a printed circuit board, or in any other suitable way, e.g. a glass or copper substrate. The MCU is coupled to a control board connector 626 that is attached to the ribbon cable 628 that is attached to the electrical connector 626 of the fourth layer 208. The MCU connects to a two-line control signal 640 that is attached to the control feed network 620. The MCU connects to 16 two-line control signals 642 that each connect to a feed network 612. As described in more detail below, the control feed network 620 receives a control signal that is passed through the control line 640 to the MCU 636. The MCU 636 generates 16 two-line control signals 642 that are each sent to a respective feed network 612 to adjust the phase of the respective feed network. In this way, the received control signal sets the configuration of the elements of the phased array of reflectors.

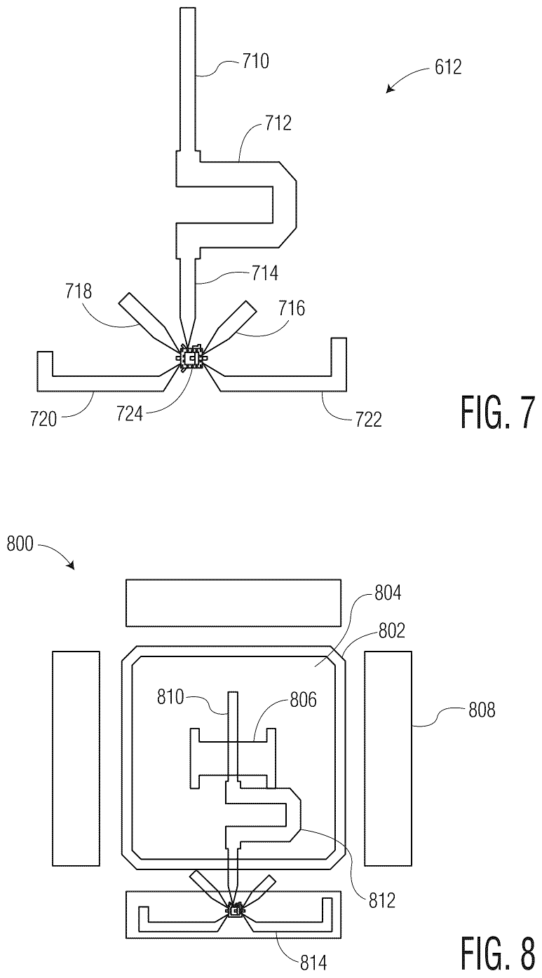

FIG. 7 is a top plan view of a feed network 612 of the fourth layer 208 of the antenna array of FIG. 2. The feed network 612 has an open stub 710 which is coupled to the excitation aperture of the layers above to receive the EM wave energy from the transmitter. The open stub 710 is coupled to a quarter wavelength transformer loop 712 which is coupled to an output stub 714. The output stub 714 is coupled to a single pole four throw (SP4T), or quadruple pole, switch 724. The SP4T switch 724 couples the output stub 714 at the single pole to one of four delay lines. There may be more or fewer delay lines with suitable changes to the switch 724, to meet the desired precision for the patch antenna. In the illustrated example, there is a 0° delay line 716, a −180° delay line 718, a −90° delay line 720, and a −270° delay line. The amount of, or degrees of, delay is determined by the length of the stub that forms the respective delay line. Each stub provides one of the four orthogonal delays to a refection from the respective patch antenna.

While 0, −90, −180, and −270 are shown, other phases may be used, e.g., −45, −135, −225, −315, or other phase combinations. There may be fewer phases, e.g., three such as 0, −90, −180. Other phases may be provided by connecting more than one stub, depending on the configuration of the switch. There may be more phases using a switch with more throws, e.g., an SP6T or SP8T switch.

The SP4T switch 724 may be configured to receive a control signal on a respective 2-line control line (not shown), e.g., from the MCU 636 through the electrical connector 616, to determine which delay lines to connect to the open stub 710. The SP4T switch 724 may be powered at the feed network 612 or through the 2-line control line by the power source 638 through the MCU 636. The delay line adjusts the delay for the respective main patch 312 of the array of main patches of the surface of the patch antenna. By adjusting the delay using multiple SP4T switches for multiple main patches, the main patches may be operated as a phased array antenna. The relative phase for each main patch is used to steer the received and transmitted beam.

FIG. 8 is a top view diagram of a block of an array showing all four layers superimposed. The block 800 has a top layer main patch 802. Below the main patch 802 is a second layer stacked patch 804 with a central aperture 806. The third layer ground plane below the excitation aperture is not shown clearly in this diagram. The fourth layer has a stub 810 below the central aperture 806 and the excitation aperture and extends transversely across the central aperture. The stub 810 is excited by EM wave energy passing through the central aperture 810.

The EM wave energy passes through a quarter wavelength transformer loop 812 to a switch and delay array 814. The main patch 802 has a parasitic element 808 on each side of the generally square main patch 802. The switch and delay array may be placed below a parasitic element to be isolated from the central aperture 806 and the stub 810.

Each block 800 of the stack has an antenna array element that includes the top layer main patch 802 stacked on the second layer stacked patch. The four smaller parasitic elements 808 are positioned on each side of the stacked patch antenna. The stacked patch and the addition of the four parasitic elements in a patch antenna design creates additional resonances and widens the antenna's return loss bandwidth.

In operation, each patch antenna of the array has an aperture-coupled stacked patch antenna that captures incoming EM wave power through the main patch 802 and central aperture 806 to the stub 810. The stub 810 and transformer loop 812 convert the captured power into guided waves through the transmission delay lines 814 through the switch. The waves are reflected back through to the main patch 802 and the re-radiated waves are manipulated in phase using the SP4T (Single Pole Four Throw) switch and delay lines. The delay lines serve to control the phase of the re-radiated wave, allowing for beam steering configurations.

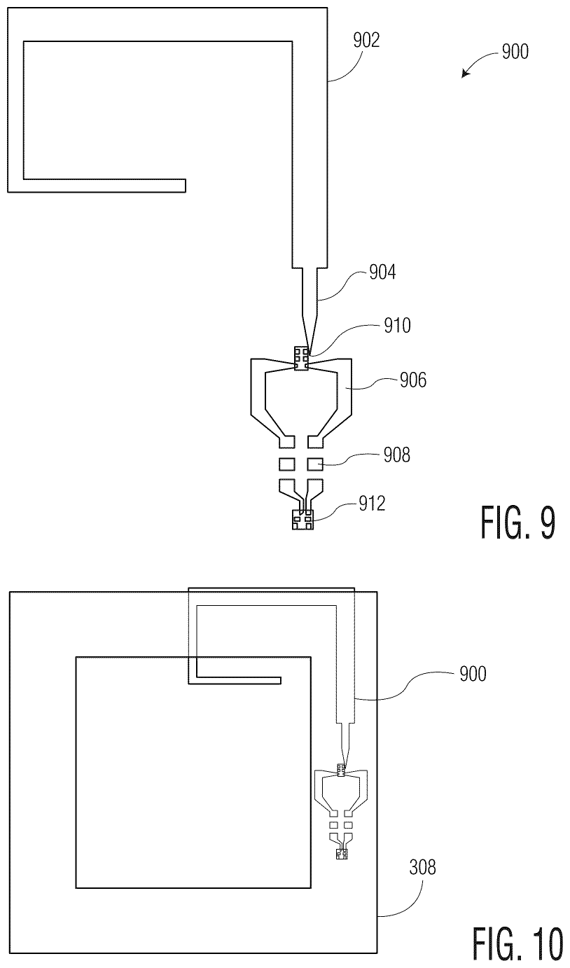

FIG. 9 is a top plan view diagram of a control signal receiver 900. The control signal receiver has a loop antenna 902 that is configured to receive the frequency, modulation, and amplitude of the intended control signals. In some embodiments, the control signals are 915 MHz RFID signals, however, other types of control signals may be used. The loop antenna 902 is coupled to an antenna feed 904 which feeds the energy into an RFID chip 910 which performs energy harvesting and reads the control signal. In some embodiments, the RFID chip 910 sends a signal back through the antenna 902 through backscattering.

The data from the RFID chip 910 is sent through a balun 906 and a lumped elements matching network 908 to a communication chip 912. The balun 906 transforms the single ended impedance from the RFID chip 910 into differential impedance for use by the communication chip 912. The matching network 908 may be configured to match the signal from the RFID chip 910 through the matching network 908 to the impedance of the communication chip 912.

The communication chip 912 may be coupled to and configured to communicate over the 2-wire control line 618. In some examples, the communication is performed using an Inter-Integrated Circuit (I2C) protocol. Accordingly, the control output may be in a form of an I2C protocol. Any suitable protocol for the nature of the control signals may be used. The shape, size, and configuration of the antenna 902 and signal path through the feed 904, balun 906 and delay elements 908 may be adapted to suit different control signals, frequencies, and packaging constraints.

In some embodiments, the data received at the communication chip 912 is sent from the communication chip 912 to the MCU 636 through the 2-wire control line. The data may be a code word, an angle for reflection, a phase, or a value for each of the elements of the array. The MCU 636 uses the data from the communications chip 912 to generate a control signal to control a switch at each of the elements of the array.

The control signal received at the control signal receiver 900 may be received from an external controller (not shown). The external controller may send control signals to multiple patch antennas using different RFIDs to configure the radio channel as appropriate for the particular application and radio environment.

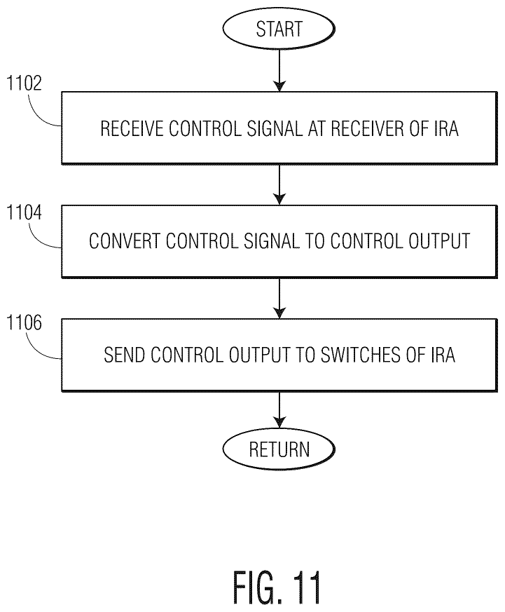

FIG. 10 shows an example configuration of the control signal receiver 900 in the fourth layer 208 below the control signal antenna 308 of the first layer 202. The control signal antenna 308 is shaped as a continuous square loop and, as shown in FIG. 3, the control signal antenna 308 may surround a main patch 312 acting as a parasitic element to the main patch 308 but as an antenna 308 for control signals. The control signal receiver 900 is directly below a surface of the loop of the control signal antenna 308. This promotes coupling between the top layer antenna and the bottom layer antenna 902. As shown, a square area of the control signal antenna 308 of the first layer is removed. This may be used to lower the center or lowest resonant frequency by increasing the average distance travelled by the lowest order resonant mode.

FIG. 11 is a process flow diagram of operating an antenna array as described herein. The operation repeats each time a new control signal is received. At 1102 a control signal is received at a control signal receiver of an antenna array, e.g., an Intelligent Reflect Array (IRA). At 1104 the control signal is converted to a control output at the control signal receiver. At 1106 the control output is sent to a plurality of switches of the antenna array, e.g., the IRA, each switch being coupled to a plurality of delay elements and to a patch antenna of the array, to set a delay for the respective patch element. The process then returns back to the start and is ready for the next control signal to be received to set the switches of the delay elements of the antenna array.

The method of FIG. 11 reflects continuous operation of the antenna array described above either upon initial configuration or over time in use. There may also be other switches, stubs, switches, elements, and controllers. The switches may be operated by an external controller that is connected to the switches to perform this operation and other tasks suitable for the system. The controller may have a processing core and memory, or it may operate using firmware or logic gates.

In embodiments, the antenna array may be scalable and operate with both 2.4 GHz and 915 MHz antennas on a shared aperture. The antenna array configuration has 16 antennas operating at, e.g., 2.4 GHz, arranged in a 4×4 array, and one, e.g., 915 MHz antenna dedicated to the control of the 16 2.4 GHz antennas. To manipulate the scanning capabilities of the antenna array, each of the 16 antennas has an SP4T switch and four delay lines of varying length to independently apply a different amount of the delay to a reflection or a re-radiation from each antenna of the antenna array.

The RFID antenna receives control signals to reconfigure the delays of the antennas on the reflection surface without a centralized controller and without a power supply. The delays being applied to a refection from the respective patch antenna. Only a small MCU and power source, e.g., a battery, is used on a small control board. The control board is mounted to the array. This greatly simplifies the wiring and controllability of the antenna array. Many 16 antenna arrays may be placed adjacent to each other to provide a larger reflection antenna array without adding to the complexity of each array. The arrays do not require any electrical connection to each other, but may each be independently controlled by a remote controller through the RFID antenna and communications chip. While a 16-block array is shown in a 4×4 configuration, the array may have more columns than rows or vice versa. A different number of blocks can be used for the array to suit different size, area, control, and frequency constraints, inter alia.

The illustrated four-layer antenna array provides enhanced coverage, improved spectral efficiency, beam management, secure communication, by controlling the radio channel, and accurate localization of the radio channel.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc. Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An antenna array comprising:
an array of patch antennas;
a plurality of delay elements associated with each patch antenna;
a switch for each patch antenna having multiple positions, each position configured to connect one delay element of a respective plurality of delay elements to a respective patch antenna; and
a controller to control the position of each switch.

2. The antenna array of claim 1, wherein the controller comprises a control signal receiver to receive an RF control signal from a remote controller.

3. The antenna array of claim 1, wherein the controller comprises a radio frequency identification chip having a control input to receive a radio control signal and a control output to control the position of each switch.

4. The antenna array of claim 3, wherein the control output is in a form of an Inter-Integrated Circuit protocol.

5. The antenna array of claim 4, wherein the control output includes an address for each switch.

6. The antenna array of claim 1, wherein each respective plurality of delay elements has four delay elements to provide four orthogonal delays to a refection from the respective patch antenna.

7. The antenna array of claim 6, wherein each respective switch is a four-throw switch to select one of the four delay elements.

8. The antenna array of claim 1, further comprising a transmission line coupled to each respective patch antenna, the transmission line having a stub coupled to the patch antenna, a quarter-wave transformer coupled to the stub, and the respective switch coupled to the quarter-wave transformer.

9. The antenna array of claim 8, wherein the delay elements comprise terminated conductive lines coupled to the switch.

10. The antenna array of claim 1, wherein each patch antenna comprises a main patch with a central aperture on a first layer, a stack patch aligned with the main patch on a second layer, and an excitation aperture aligned with the central aperture on a ground layer, wherein the first layer, the second layer, and the ground layer are attached together.

11. The antenna array of claim 10, wherein the main patch and the stack patch are formed of an approximately square layer of material at the respective layer.

12. The antenna array of claim 11, further comprising parasitic elements surrounding each main patch on the first layer.

13. A method comprising:
receiving a control signal at a control signal receiver of an antenna array, the antenna array having a plurality of delay elements;
converting the control signal to a control output at the control signal receiver; and
sending the control signal output to a plurality of switches of the antenna array, each switch being coupled to a respective delay element of a patch antenna of the antenna array, to set a delay for the respective patch element.

14. The method of claim 13, wherein the control signal receiver comprises a radio frequency identification chip having a control input to receive a radio control signal and a control output to control the position of each switch.

15. The method of claim 13, wherein sending the control signal output comprises sending an Inter-Integrated Circuit signal.

16. The method of claim 13, wherein sending the control signal output comprises sending an indication of one of four switch positions to each switch.

17. The method of claim 13, wherein sending the control signal output comprises sending a separate two-line control signal to each switch.

18. A controller comprising:
a control signal receiver configured to receive a control signal through a radio signal; and
a micro-controller unit (MCU) coupled to the control signal receiver configured to receive the control signal from the control signal receiver and to generate a control output to control the position of each of a plurality of switches, each switch being coupled to a respective delay element of a patch antenna of an antenna array to set a delay for the respective patch element.

19. The controller of claim 18, wherein the control signal receiver is positioned on a patch antenna, the controller further comprising a control board configured to carry the MCU and having a connector to connect to the control signal receiver.

20. The controller of claim 18, wherein the control signal receiver comprises a radio frequency identification (RFID) chip having a control input.
